(19) United States
(12) Patent Application Publication
(10) Pub. No.: US 2007/0139365 A1
(43) Pub. Date: Jun. 21, 2007

(54) PORTABLE ELECTRONIC DEVICE WITH A FUNCTION OF DISPLAYING A PERSONAL FAVORITE COMPUTER ENVIRONMENT FOR USER

(75) Inventors: Xiao-Guang Li, Shenzhen (CN); Kuan-Hong Hsieh, Shenzhen (CN); Wen-Chuan Lian, Shenzhen (CN); Han-Che Wang, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,527

(22) Filed: Aug. 17, 2006

(30) Foreign Application Priority Data
Dec. 21, 2005 (CN) 200510121017.3

(51) Int. Cl. G09G 5/00

(52) U.S. Cl. 345/156

(57) ABSTRACT

A preferred embodiment of a method of this invention includes the following steps: changing a configuration data pointer of the computer from pointing to the computer configuration data of the computer to pointing to the preferred computer configuration data of the portable electronic device, and simultaneously, the computer changing a disk pointer of the computer from pointing to a main data storage of the computer to pointing to the data storage; connecting to the network server through an internet connection and accessing the “my folders” of the network server, according to the address data in the portable electronic device; changing the configuration data pointer from pointing to the preferred computer configuration data to pointing to the computer configuration data, and simultaneously, changing the disk pointer from pointing to the “my folders” to pointing to the main data storage, when the connection between the computer and the portable electronic device is disabled.

### 1. TECHNICAL FIELD

The present invention generally relates to a portable electronic device with a function of displaying a personal favorite computer environment for user.

### 2. GENERAL BACKGROUND

Computers have become necessary tools in people's daily lives, and have become a preferred choice of tool when it comes to storing information. Storing information in a computer allows the information to be more easily shared and distributed.

Users operate computers at different places such as at home or at work. Users may also choose to use shared computers not belonging to them when their own computers are not accessible. Using the shared computers would mean accessing the systems thereof, thus jeopardizing the security of the data stored within. Additionally, when using shared computers, the computer environments setup may not be that of the user's favorite computer environment.

By using an external hard disk, a user may use a hard disk tray to couple the external hard disk into another computer's hard disk bay. The system configuration stored in the external hard drive would allow using the resources of the other computer's without accessing the data stored within. However, one shortcoming of the removable external hard disk is that it is too expensive and too heavy, resulting in inconveniences when carrying it. Another shortcoming of the external hard drive is that the computer that uses it must have a hard disk bay itself, and this is not common.

A notebook could also solve the above problem but it is even more expensive and heavier.

What is needed is a portable electronic device which has less weight and less cost, allowing a user to use a shared computer's resources without accessing the data, and setting up a preferred computer environment accustomed to the user.

### SUMMARY

A portable electronic device with function of displaying a personal favorite computer environment for user is provided. A preferred embodiment of the portable electronic device includes a transmitting interface, a microcontroller unit, and a data storage. The transmitting interface is for performing a data communications between a computer and the portable electronic device. The data storage is for storing an address data, a preferred computer configuration data, and an application program; and the microcontroller unit connects to the transmitting interface and the storage and is for controlling the data communications between the portable electronic device and the computer. The application program includes an operation module and a pointer reset module. The operation module is for changing a configuration data pointer of the computer from pointing to a computer configuration data of the computer to pointing to the preferred computer configuration data of the portable electronic device, and simultaneously, changing a disk pointer of the computer from pointing to the main data storage to pointing to the data storage, thereby connecting to the network server through an internet connection and accessing the “my folders” of the network server, according to the address data in the portable electronic device.

The pointer reset module is for changing the configuration data pointer of the computer from pointing to the preferred computer configuration data of the portable electronic device to pointing to the computer configuration data of the computer, and simultaneously, changing the disk pointer of the computer from pointing to the “my folders” of the network server to pointing to the main data storage of the computer.

A method for implementing a portable electronic device with function of displaying a personal favorite computer environment for user is provided. A preferred embodiment of the method includes connecting the portable electronic device to a computer, wherein, the portable electronic device includes a transmitting interface, a microcontroller unit, and a data storage; changing a configuration data pointer of the computer from pointing to the computer configuration data of the computer to pointing to the preferred computer configuration data of the portable electronic device, and simultaneously, the computer changing a disk pointer of the computer from pointing to the main data storage to pointing to the data storage; connecting to the network server through an internet connection and accessing the “my folders” of the network server, according to the address data in the portable electronic device; changing the configuration data pointer of the computer from pointing to the preferred computer configuration data of the portable electronic device to pointing to the computer configuration data of the computer, and simultaneously, changing the disk pointer of the computer from pointing to the “my folders” of the network server to pointing to the main data storage of the computer, when the connection between the computer and the portable electronic device is disabled.

Other advantages and novel features will be drawn from the following detailed description of exemplary embodiments with reference to the attached drawings, in which:

### BRIEF DESCRIPTION OF THE DRAWINGS

FIG. 1 is a block diagram of a preferred embodiment linking a portable electronic device and a computer in accordance of the present invention;

FIG. 2 is a schematic diagram of main function modules of the application program of FIG. 1; and

FIG. 3 is a flow chart of a preferred method for implementing data communications between the portable electronic device and the computer of FIG. 1, utilizing the application program.

### DETAILED DESCRIPTION OF THE PREFERRED EMBODIMENT

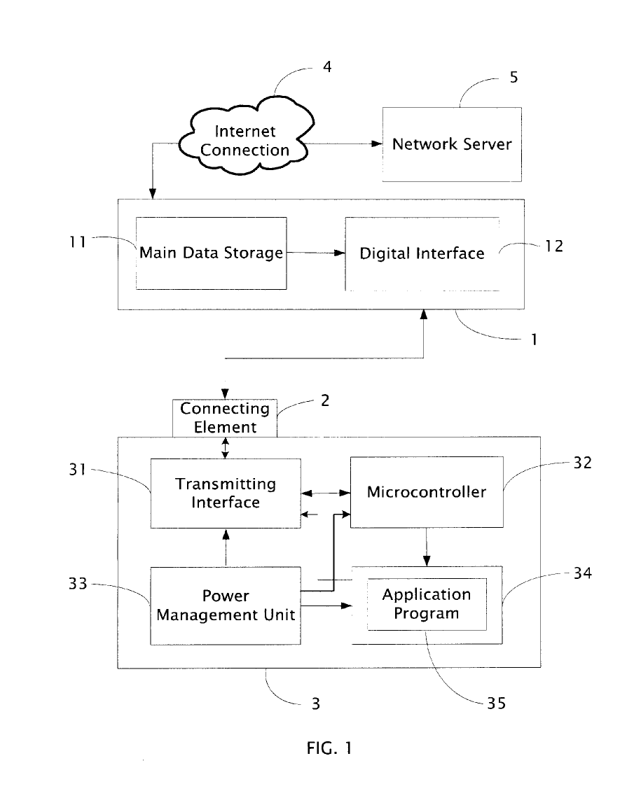

FIG. 1 is a block diagram of a preferred embodiment linking a portable electronic device and a computer in accordance of the present invention. The computer 1 connects to the portable electronic device 3 and configures a preferred computer environment for operating the portable electronic device 3. The computer 1 includes a main data storage 11 and a digital interface 12. The main data storage 11 has a driver therein for driving the portable electronic device 3. The digital interface 12 provides an interface for connecting the portable electronic device 3 thereto. Additionally, the portable electronic device 3 provides a connecting element 2 to connect with the computer 1. The connecting element 2 is also of a digital interface. The connecting element 2 could be separated from or incorporated within the portable electronic device 3. For simplicity, in such case, the former (such as that shown in FIG. 1) is adopted.

The portable electronic device 3 (e.g., mouse) includes a transmitting interface 31, a microcontroller unit 32, a power management unit 33, and a data storage 34. The microcontroller unit 32 is for controlling data communications between the main data storage 11 of the computer 1 and the data storage 34 of the portable electronic device 3. Under the control of the microcontroller unit 32, the transmitting interface 31 either receives data from the main data storage 11 or outputs data from the data storage 34 through the digital interface 12 and the connecting element 2, thereby performing data communications. The power management unit 33 supplies power to the transmitting interface 31, the microcontroller unit 32, and the data storage 34.

The data storage 34 is for storing address data, a preferred computer configuration data, and an application program 35. The address data include an address of a network server 5 and one or more addresses of “my folders” of the network server 5. “my folders” is for storing important or frequently used data. “my folders” can be general folders such as, for example, my favorite folder, my document folder of a windows operation system, and/or some other user-defined folders. The preferred computer configuration data includes a preferred computer environment configuration data and a general applications configuration data. The preferred computer environment configuration data is for setting a preferred computer environment that a user of the portable electronic device is familiar. The preferred computer environment configuration data further includes one or more folder pointers for pointing to the address data of the user-defined folder in the network server 5. The general applications configuration data is for setting general applications according to the users' personal preference. The general applications can be such as, for example, Microsoft Word, Microsoft Excel, and so on.

The application program 35 automatically installs into the computer 1 once the portable electronic device 3 is connected to the computer 1 and automatically uninstalls from the computer 1 when the connection between the computer 1 and the portable electronic device 3 is disabled. The application program 35 may also be downloaded from a network server 5 once the portable electronic device 3 is connected to the computer 1 and automatically uninstalls from the computer 1 when the connection between the computer 1 and the portable electronic device 3 is disabled.

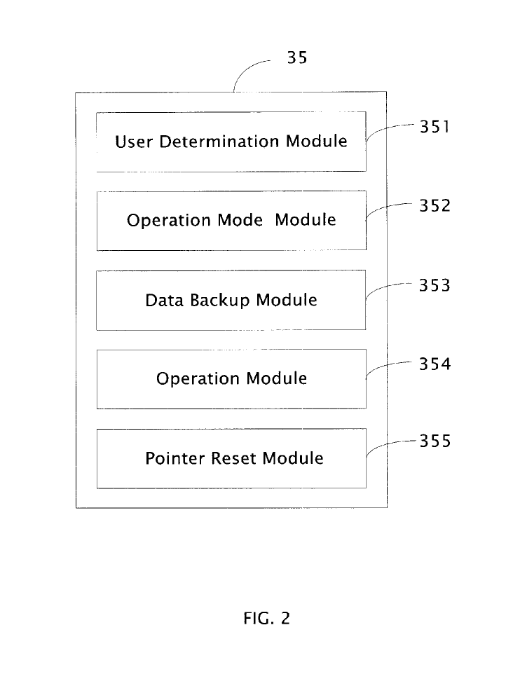

FIG. 2 is a schematic diagram of function modules of the application program 35. The application program 35 includes a user identification module 351, an operation mode module 352, a backup module 354, an operation module 353, and a pointer reset module 355.

The user identification module 351 is for determining whether the user operating the portable electronic device 3 is an authorized user through a password authentication system. The user identification module 351 further provides a dialog box on the computer 1 for the user to input a valid username and a valid password once the portable electronic device 3 is connected to the computer 1. The user identification module 351 rejects access to the data of the portable electronic device 3 if the username or the password inputted is not valid, thereby enhancing the security of the data thereof.

The operation mode module 352 is for determining an operation mode of the computer 1 according to the user's choice. The operation mode includes a host mode and a client mode.

The operation module 353 is for controlling the communication between the computer 1 and the portable electronic device 3. For example, if the operation mode of the computer 1 is the client mode, the computer 1 changes the configuration data pointer of the computer 1 from pointing to the computer configuration data of the computer 1 to pointing to the preferred computer configuration data of the portable electronic device 3. Simultaneously, the computer 1 changes the disk pointer of the computer 1 from pointing to the main data storage 11 to pointing to the data storage 34, thereby obtaining the preferred computer configuration data and the address data therefrom. Consequently, the computer 1 configures the preferred computer environment according to the preferred computer environment configuration data, thereby, the user can operate on the computer 1 in the preferred computer environment. In addition, the computer 1 connects to the network server 5 through an internet connection 4 and accesses the “my folders” of the network server 5 according to the address data, thereby shielding the main data storage 11 of the computer 1 from being accessed.

The backup module 354 is for operating the portable electronic device 3 in the host mode. In the host mode, the backup module 354 saves documents from the computer 1 into the “my folders” of the network server 5 if the “my folders” exists in the network server 5. In addition, the backup module 354 also records addresses of “my folders” into the portable electronic device 3 if the “my folders” is a newly created folder, and simultaneously, a corresponding folder pointer is automatically generated in the preferred computer environment configuration data to point to the newly created folder.

The pointer reset module 355 is for resetting addresses pointed by the configuration data pointer and the disk pointer of the computer 1 when the connection between the computer 1 and the portable electronic device 3 is disabled. That is, the pointer reset module 354 changes the configuration data pointer of the computer 1 from pointing to the preferred computer configuration data of the portable electronic device 3 to pointing to the computer configuration data of the computer 1. Simultaneously, the pointer reset module 356 changes the disk pointer of the computer 1 from pointing to the “my folders” of the network server 5 to pointing to the main data storage 11 of the computer 1.

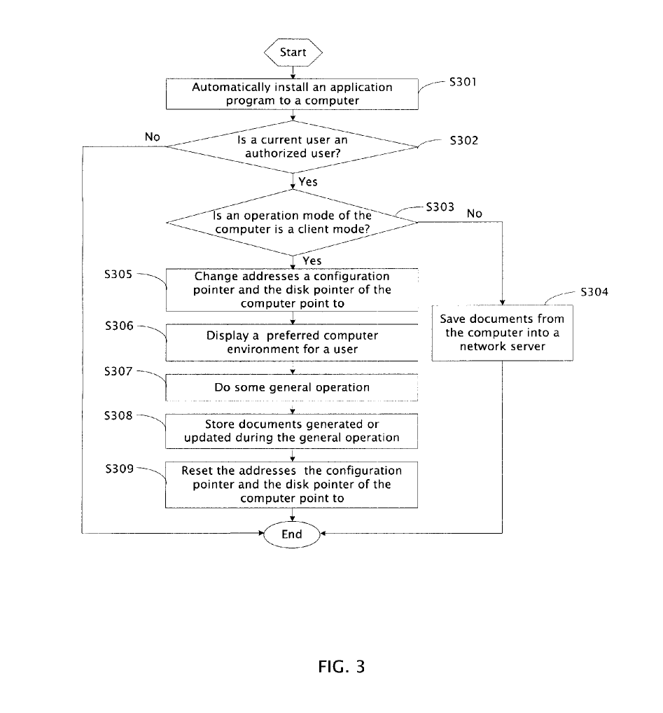

FIG. 3 is a flow chart of a preferred method of implementing the data communications between the computer 1 and the portable electronic device 3 utilizing the application program 35.

In step S301, the application program 35 automatically installs itself into the computer 1 once the computer 1 is connected to the portable electronic device 3.

In step S302, the user identification module 351 determines whether the user operating on the portable electronic device 3 is an authorized user of the portable electronic device 3 according to the username and the password inputted. If the user operating on the portable electronic device 3 is not an authorized user of the portable electronic device 3, the application program 35 ends.

In step 303, the operation mode module 352 determines whether the operation mode of the computer 1 is in the client mode according to the user's selection.

In step 304, if the operation mode of the computer 1 is the host mode, the backup module 354 saves documents from the computer 1 into the “my folders” of the network server 5 if the “my folders” exists in the network server 5 and the backup module 354 also records addresses of “my folders” into the portable electronic device 3 if the “my folders” is a newly created folder, and simultaneously, a corresponding folder pointer is automatically generated in the preferred computer environment configuration data to point to the newly created folder.

In step 306, if the operation mode of the computer 1 is in the client mode, the computer 1 changes a configuration data pointer of the computer 1 from pointing to the computer configuration data of the computer 1 to pointing to the preferred computer configuration data of the portable electronic device 3. Simultaneously, the computer 1 changes a disk pointer of the computer 1 from pointing to the main data storage 11 to pointing to the data storage 34.

In step 307, the computer 1 accesses the data storage 34 to obtain the preferred computer configuration data, thus configuring the preferred computer environment according to the preferred computer environment configuration data. Simultaneously, the computer 1 connects to the network server 5 through the internet connection 4 and accesses the “my folders” of the network server 5 according to the address data in the portable electronic device 3.

In step S308, the computer executes general operations such as reading, writing, or modifying files on the computer 1 when necessary.

In step 309, documents generated or updated by general operations are automatically stored to the “my folders” of network server 5 if the “my folders” exists in the network server 5. If the “my folders” is the newly created folder the addresses of the newly created folder is recorded into the portable electronic device 3 and simultaneously, a corresponding folder pointer is automatically generated in the preferred computer environment configuration data to point to the newly created folder.

In step 310, when the connection between the computer 1 and the portable electronic device 3 is disabled, the pointer reset module changes the configuration data pointer of the computer 1 from pointing to the preferred computer configuration data of the portable electronic device 3 to pointing to the computer configuration data of the computer 1, and simultaneously, the pointer reset module 356 changes the disk pointer of the computer 1 from pointing to the “my folders” of the network server 5 to pointing to the main data storage 11 of the computer 1.

Although the present invention has been specifically described on the basis of a preferred embodiment, the invention is not to be construed as being limited thereto. Various changes or modifications may be made to the embodiment without departing from the scope and spirit of the invention.

What is claimed is:

1. A portable electronic device with function of displaying a personal favorite computer environment for a user, the portable electronic device comprising:
a transmitting interface for performing data communications between a computer and the portable electronic device;
a data storage for storing an address data, a preferred computer configuration data, and an application program; and
a microcontroller unit, connected to the transmitting interface and the storage, for controlling the data communications between the portable electronic device and the computer;
wherein the application program comprises:
an operation module for changing a configuration data pointer of the computer from pointing to a computer configuration data of the computer to pointing to the preferred computer configuration data of the portable electronic device, and simultaneously, changing a disk pointer of the computer from pointing to a main data storage of the computer to pointing to the data storage, thereby connecting to a network server through an internet connection and accessing “my folders” of the network server, according to the address data;
a pointer reset module for changing the configuration data pointer of the computer from pointing to the preferred computer configuration data of the portable electronic device to pointing to the computer configuration data of the computer, and simultaneously, changing the disk pointer of the computer from pointing to the “my folders” of the network server to pointing to the main data storage of the computer.

2. The portable electronic device as described in claim 1, wherein, the address data is for recording an address of a network server and one or more addresses of “my folders” of the network server.

3. The portable electronic device as described in claim 1, wherein, the preferred computer configuration data comprises a preferred computer environment configuration data for setting a preferred environment for the user.

4. The portable electronic device as described in claim 1, wherein, the preferred computer configuration data further comprises a general applications configuration data for setting general applications according to users' personal preference.

5. The portable electronic device as described in claim 1, wherein, “my folders” are backups of important or frequently used data from the computer.

6. The portable electronic device as described in claim 1, wherein, the application program further comprises a user identification module for determining whether a user operating on the portable electronic device is an authorized user through a password authentication system.

7. The portable electronic device as described in claim 1, wherein, the application program further comprises a backup module for saving documents from the computer into the “my folders” of the network server if the “my folders” exists in the network server.

8. The portable electronic device as described in claim 7, wherein the backup module is also for recording addresses of “my folders” into the portable electronic device if the “my folders” is a newly created folder, and simultaneously, automatically generating a corresponding folder pointer in the preferred computer environment configuration data to point to the newly created folder.

9. The portable electronic device as described in claim 1, wherein, the operation mode of the computer includes a client mode and a host mode.

10. The portable electronic device as described in claim 9, wherein, the application program further comprises an operation module for determining an operation mode of the computer according to users' selection.

11. A method for implementing a portable electronic device with function of displaying a personal favorite computer environment for user, comprising:
connecting the portable electronic device to a computer, wherein the portable electronic device comprises a transmitting interface, a microcontroller unit, and a data storage, the data storage stores an address data, a preferred computer configuration data, and an application program executed on the computer;
changing a configuration data pointer of the computer from pointing to the computer configuration data of the computer to pointing to the preferred computer configuration data of the portable electronic device, and simultaneously, changing a disk pointer of the computer from pointing to a main data storage of the computer to pointing to the data storage;
connecting to the network server through an internet connection and accessing the “my folders” of the network server, according to the address data in the portable electronic device;
changing the configuration data pointer of the computer from pointing to the preferred computer configuration data of the portable electronic device to pointing to a computer configuration data of the computer, and simultaneously, changing the disk pointer of the computer from pointing to the “my folders” of the network server to pointing to the main data storage of the computer, when the connection between the computer and the portable electronic device is disabled.

12. The portable electronic device as described in claim 11, wherein, the address data is for recording an address of a network server and one or more addresses of “my folders” of the network server.

13. The portable electronic device as described in claim 11, wherein, the preferred computer configuration data includes a preferred computer environment configuration data for setting a preferred favorite computer environment for the user.

14. The portable electronic device as described in claim 11, wherein, the preferred computer configuration data comprises a general applications configuration data is for setting general applications according to personal preference.

15. The portable electronic device as described in claim 11, wherein, the “my folders” are backups of important or used frequently data from the computer.

16. The portable electronic device as described in claim 11, wherein, the operation mode of the computer includes a client mode and a host mode.

17. The portable electronic device as described in claim 11, wherein, further comprising the step of determining whether the user is the authorized user after connecting the portable electronic device to a computer.

18. The portable electronic device as described in claim 16, wherein, further comprising the step of determining the operation mode of the computer before changing a configuration pointer of the computer.

19. The portable electronic device as described in claim 11, wherein, further comprising the step of recording addresses of “my folders” into the portable electronic device if the “my folders” is a newly created folder when saving or backup documents into the “my folders”.

20. The portable electronic device as described in claim 11, wherein, further comprising the step of automatically generating a corresponding folder pointer in the preferred computer environment configuration data to point to the newly created folder.
